(19) United States
(12) Patent Application Publication
(10) Pub. No.: US 2021/0041045 A1
(43) Pub. Date: Feb. 11, 2021

(54) AXIAL SWAGED FITTING

(71) Applicant: TYLOK INTERNATIONAL, INC., Cleveland, OH (US)

(72) Inventors: Vincent P. TRAINA, Cleveland, OH (US); Donald A. LEVENGOOD, Cleveland, OH (US); Charles W. HAHL, Cleveland, OH (US)

(21) Appl. No.: 16/964,266

(22) PCT Filed: Jan. 28, 2019
(86) PCT No.: PCT/US2019/015364

§ 371 Date: Jul. 23, 2020

Related U.S. Application Data
(60) Provisional application No. 62/623,071, filed on Jan. 29, 2018.

(51) Int. Cl. F16L 13/14; F16L 13/16

(52) U.S. Cl. CPC F16L 13/146; F16L 13/16

(57) ABSTRACT

An axial swaged fitting for permanently joining to a tube to achieve an elastic strain preload condition comprises an annular body including a detent step. An annular driver includes a driver detent feature. The driver is configured for selective distal sliding motion with respect to the tube and body to bring the driver detent feature into selective engagement with the detent step at least partially via elastic deformation of the driver detent feature. At least one swage ring is laterally interposed between the tube and the driver. The driver selectively exerts a predetermined compression force laterally inward toward the tube to urge the at least one swage ring into a sealing contact with the tube and responsively place the tube into the elastic strain preload condition. The driver detent feature concurrently engages the detent step to resist proximal motion of the driver with respect to the body.

### RELATED APPLICATION

This application claims priority from U.S. Provisional Application No. 62/623,071, filed 29 Jan. 2018, the subject matter of which is incorporated herein by reference in its entirety.

### TECHNICAL FIELD

This disclosure relates to an apparatus and method for use of an axial swaged fitting and, more particularly, to an axial swaged fitting for permanently joining to a tube to achieve an elastic strain preload condition.

### BACKGROUND

Permanent fittings are commonly used for connecting metal tubes, conduits, and pipes to each other for use in a variety of applications, for example for the conveyance of gasses, liquids, or other fluids in the medical, aerospace, automotive or other vehicle, construction, or many other industries. It is desirable for the connection between the tubes and fitting to be secure in order to withstand vibrations and adverse conditions, and to be substantially fluidtight to prevent leakage of the carried gasses, liquids, or other fluid from the finished piping assembly.

### SUMMARY

In an aspect, an axial swaged fitting for permanently joining to a tube to achieve an elastic strain preload condition is provided. The fitting comprises an annular body including a tube bore laterally surrounding at least a portion of the tube. The annular body includes a detent step laterally aligned with at least a portion of the tube bore. The annular body includes a tapered proximal body extension. An annular driver includes a driver detent feature longitudinally spaced from a ring driving lip. The driver detent feature directly laterally surrounds the proximal body extension. The ring driving lip directly laterally surrounds a portion of the tube. The driver is configured for selective distal sliding motion with respect to the tube and body to bring the driver detent feature into selective engagement with the detent step at least partially via elastic deformation of the driver detent feature under influence of the tapered proximal body extension. At least one swage ring is laterally interposed between the tube and the driver. The swage ring includes a tapered distal ring edge laterally interposed between the proximal body extension and the tube. The swage ring includes a proximal ring edge configured for selective engagement with the ring driving lip. The driver selectively exerts a predetermined compression force laterally inward toward the tube to urge the at least one swage ring into a sealing contact with the tube and responsively place the tube into the elastic strain preload condition. The driver detent feature concurrently engages the detent step to resist proximal motion of the driver with respect to the body.

In an aspect, an axial swaged fitting for permanently joining to a tube is provided. The fitting comprises an annular body including laterally spaced, concentrically extending, and oppositely facing inner body and outer body surfaces. The inner body surface includes a tube bore directly adjacent to an outer tube surface of the tube. The outer body surface includes at least one detent step laterally aligned with at least a portion of the tube bore. The annular body includes a tapered proximal body extension having a proximal body rim interposed laterally between the inner body and outer body surfaces. The outer and inner body surfaces taper toward each other in a proximal direction. An annular driver includes laterally spaced, concentrically extending, and oppositely facing inner driver and outer driver surfaces. The outer driver surface includes a driver detent feature longitudinally spaced from a ring driving lip of the inner driver surface. The inner driver surface tapers laterally outward in a distal direction. The driver detent feature directly laterally surrounds the proximal body extension. The ring driving lip directly laterally surrounds a portion of the tube. The driver is configured for selective distal sliding motion with respect to the tube and body to bring the driver detent feature into selective engagement with the detent step at least partially via elastic deformation of the driver detent feature under influence of wedging interaction between the inner driver surface and the tapered proximal body extension. At least one swage ring is laterally interposed between the tube and the driver. The swage ring includes a tapered distal ring edge laterally interposed between the proximal body extension and the tube. The swage ring includes a proximal ring edge configured for selective engagement with the ring driving lip. The driver selectively exerts a predetermined compression force laterally inward toward the tube to urge the at least one swage ring into a sealing contact with the tube and responsively place the tube into the elastic strain preload condition. The driver detent feature concurrently engages the detent step to resist proximal motion of the driver with respect to the body.

In an aspect, a method of permanently joining an axial swaged fitting to a tube to achieve an elastic strain preload condition is provided. A portion of the tube is laterally surrounded with an annular body including a detent step. At least a portion of the body is laterally surrounded with an annular driver including a driver detent feature longitudinally spaced from a ring driving lip. At least one swage ring is laterally imposed between the tube and the driver. The body and driver are brought into at least partial lateral contact. The driver is brought into at least partial lateral contact with the at least one swage ring. The driver is slid longitudinally distally along the body. With the driver, a predetermined force is exerted at least one of laterally inward toward the tube and longitudinally distally. With the predetermined compression force, the at least one swage ring is urged laterally inward to deform the tube to achieve the elastic strain preload condition. The detent step and driver detent feature are engaged via elastic deformation of the driver. The elastic strain preload condition is maintained through cooperative engagement of the detent step and the driver detent feature.

### BRIEF DESCRIPTION OF THE DRAWINGS

For a better understanding, reference may be made to the accompanying drawings, in which:

FIG. 1 is a schematic cross-sectional view of an aspect of the present invention, including two example use configurations;

FIG. 2 is a partial exploded view of the aspect of FIG. 1;

FIG. 3 is a perspective view of the aspect of FIG. 1;

FIG. 4 is a partial sectional view of the aspect of FIG. 1 in the first example use configuration;

FIG. 5 is a partial sectional view of the aspect of FIG. 1 in the second example use configuration;

FIG. 6 is a partial schematic detail view of area “6” in FIG. 5; and

FIG. 7 is a schematic cross-sectional view of the aspect of FIG. 1 including an alternate component.

### DESCRIPTION OF ASPECTS OF THE DISCLOSURE

Unless defined otherwise, all technical and scientific terms used herein have the same meaning as is commonly understood by one of skill in the art to which the present disclosure pertains.

As used herein, the singular forms “a,” “an” and “the” can include the plural forms as well, unless the context clearly indicates otherwise. It will be further understood that the terms “comprises” and/or “comprising,” as used herein, can specify the presence of stated features, steps, operations, elements, and/or components, but do not preclude the presence or addition of one or more other features, steps, operations, elements, components, and/or groups thereof.

As used herein, the term “and/or” can include any and all combinations of one or more of the associated listed items.

It will be understood that when an element is referred to as being “on,” “attached” to, “connected” to, “coupled” with, “contacting,” etc., another element, it can be directly on, attached to, connected to, coupled with or contacting the other element or intervening elements may also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “directly adjacent” another feature may have portions that overlap or underlie the adjacent feature, whereas a structure or feature that is disposed “adjacent” another feature might not have portions that overlap or underlie the adjacent feature.

Spatially relative terms, such as “under,” “below,” “lower,” “over,” “upper” and the like, may be used herein for ease of description to describe one element or feature's relationship to another element(s) or feature(s) as illustrated in the figures. It will be understood that the spatially relative terms can encompass different orientations of a device in use or operation, in addition to the orientation depicted in the figures. For example, if a device in the figures is inverted, elements described as “under” or “beneath” other elements or features would then be oriented “over” the other elements or features.

As used herein, the phrase “at least one of X and Y” can be interpreted to include X, Y, or a combination of X and Y. For example, if an element is described as having at least one of X and Y, the element may, at a particular time, include X, Y, or a combination of X and Y, the selection of which could vary from time to time. In contrast, the phrase “at least one of X” can be interpreted to include one or more Xs.

It will be understood that, although the terms “first,” “second,” etc. may be used herein to describe various elements, these elements should not be limited by these terms. These terms are only used to distinguish one element from another. Thus, a “first” element discussed below could also be termed a “second” element without departing from the teachings of the present disclosure. The sequence of operations (or steps) is not limited to the order presented in the claims or figures unless specifically indicated otherwise.

The invention comprises, consists of, or consists essentially of the following features, in any combination.

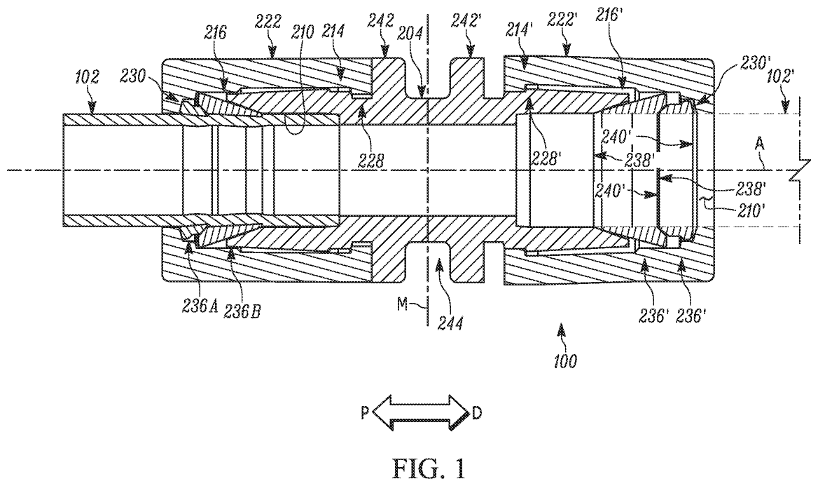

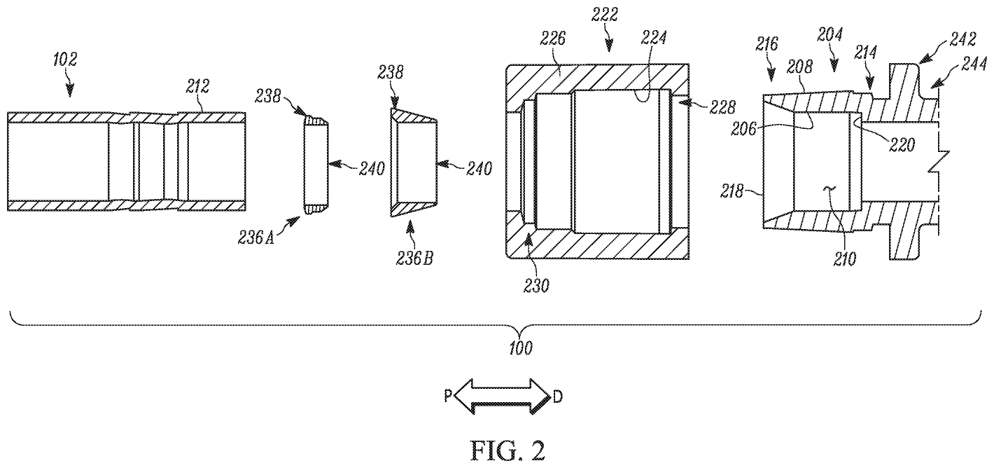

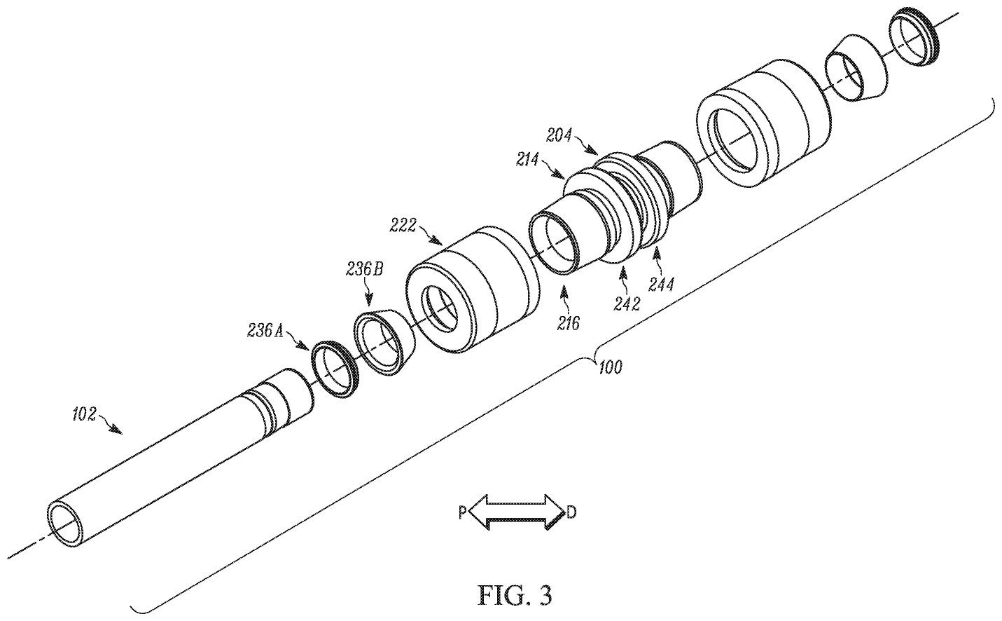

FIG. 1 depicts an axial swaged fitting 100 for permanently joining to a tube 102 to achieve an elastic strain preload condition. As shown in the exploded view of FIG. 2, the fitting 100 includes an annular body 204 including laterally spaced, concentrically extending, and oppositely facing inner body and outer body surfaces 206 and 208, respectively. The “lateral” direction is substantially perpendicular to the longitudinal direction (represented by arrow P-D) in FIGS. 1-2—i.e., the lateral plane extends substantially vertically and is viewed edge-on, in the orientation of FIGS. 1-2. As shown in at least FIGS. 1 and 3, the annular body 204 is substantially mirrored about line “M” to allow for end-to-end connection of two tubes 102, as will be described further below. However, the below description initially concentrates on the leftmost portion of the annular body 204 (as shown in FIG. 2), for clarity of description.

The inner body surface 206 includes a tube bore 210 directly adjacent to an outer tube surface 212 of the tube 102. The outer body surface 208 includes at least one detent step 214 laterally aligned with at least a portion of the tube bore 210. The term “laterally aligned” is used herein to indicate that at least some portion of each of the “laterally aligned” structures are located in the same lateral plane (again, a plane taken perpendicular to the longitudinal direction represented by arrow P-D in the Figures). The annular body 204 includes a tapered proximal body extension 216. The “proximal” direction, in the Figures, references a longitudinal direction that is toward the left of the page, in the orientation of the Figures. Conversely, a “distal” direction, as used herein, is longitudinal and oppositely facing from the proximal direction—so, toward the right of the page, in the orientation of the Figures.

The proximal body extension 216 has a proximal body rim 218 interposed laterally between the inner body and outer body surfaces 206 and 208. The outer and inner body surfaces 206 and 208 taper inward toward each other as the annular body 204 extends in the proximal direction. Accordingly, the proximal body rim 218 is “suspended” laterally and is located further toward a center axis “A” of the fitting 100 than is the outermost portion of the outer body surface 208 and further away from the center axis “A” of the fitting than is the innermost portion of the inner body surface 206. The body 204 laterally surrounds at least a portion of the tube 102, as shown in FIG. 1, during assembly, installation, and use of the fitting 100, through acceptance of the tube 102 into the tube bore 210. It is contemplated that a tube stop 220 could be provided to limit insertion of the tube 102 into the tube bore 210 and thereby achieve desired and repeatable placement of the tube 102 relative to the annular body 204.

An annular driver 222 includes laterally spaced, concentrically extending, and oppositely facing inner driver and outer driver surfaces 224 and 226, respectively. The inner driver surface 224 includes a driver detent feature 228 longitudinally spaced from a ring driving lip 230 of the inner driver surface 224. The inner driver surface 224 tapers laterally outward away from the center axis A as the annular driver 222 extends in the distal direction. That is, the proximalmost portion of the inner driver surface 224 is located laterally closer to the center axis than is the distalmost portion of the inner driver surface 224.

The driver detent feature 228 directly laterally surrounds the proximal body extension 218. The ring driving lip 230 directly laterally surrounds a portion of the tube 102. The driver 222 is configured for selective distal sliding motion with respect to the tube 102 and body 204, to bring the driver detent feature 228 into selective engagement with the detent step 214. This engagement, which will be discussed in more detail below, occurs at least partially via elastic deformation of the driver detent feature 228 under influence of wedging interaction (with resultant forces developing) between the inner driver surface 224 and the tapered proximal body extension 216.

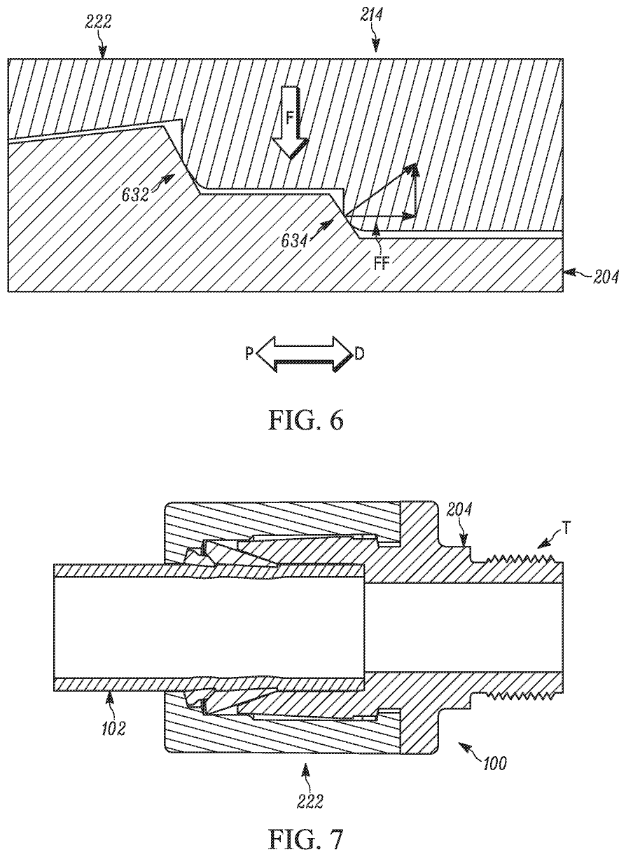

With reference now to FIG. 6, a magnified view of the configuration of the detent step 214 and driver detent feature 228 is provided. In FIG. 6, for ease of depiction, the fitting 100 is shown in a fully installed condition. As can be seen, the detent step 214 includes an assembly detent feature 632 and an installation detent feature 634. The assembly detent feature 632 is laterally further from the tube bore 210 than is the installation detent feature 634. Both of the assembly and installation detent features 632 and 634 extend laterally further from the tube bore 210 than does the driver detent feature 228 when the driver detent feature 228 is not engaged with the detent step 214. That is, the driver detent feature 228 is “splayed” or forced outward—into diametrical expansion—from its natural, steady state resting configuration, via interaction with the proximal body extension 216 (and/or other portions of the body 204). Then, even though the driver detent feature 228 is permitted to release (or “snap”) back laterally inward toward the central axis A once it has passed distally past one or both of the assembly and installation detent features 632 and 634, it is still held in some tension outward, in elastic deformation, away from its natural, steady state resting configuration. The term “snap” is used herein to indicate a release of energy under elastic deformation, as the elastically deformed component returns toward its undeformed state—it should be understood that there might not be an actual “snapping” sound or sudden movement with an action described herein as “snapping”. One of ordinary skill in the art could even provide components including features intended to dampen or soften any “snap” action, but those components would still be considered to fall under the present invention despite a more controlled release of the elastic deformation energy.

This elastic deformation of the driver detent feature 228 at least partially provides a compressive hoop force “F” (shown in FIG. 6) which tends to pull the driver 222 distally forward onto the angles of the assembly and installation detent features 632 and 634, creating a distally forward force/action. This distally forward force/action will cause the driver 222 (and any associated structures) to be constantly pulled forward, thus creating an additional “live loading” on the fitting 100 connection, which may be desirable for maintaining a fluidtight connection between the tube 102 and the fitting 100. This “live loading” forms a component of an elastic strain preload arrangement.

As will be understood by one of ordinary skill in the art, the detent step 214 may be engaged, and maintained in engagement, with the assembly detent feature 632 during a manufacturing operation which occurs a significant amount of time before the detent step 214 is engaged, and maintained in engagement, with the installation detent feature 634 during an installation operation. It is contemplated that the manufacturing operation may be performed by a manufacturer at a factory site and the installation by an end user at a job site. “A significant amount of time” is used herein to indicate a time period of at least days, during which the fitting 100 can be sold, distributed, transported, and/or stored for installation by an end user.

With reference back to FIGS. 1-2, at least one swage ring 236 may be laterally interposed between the tube 102 and the driver 222. (Two rings, 236A and 236B, are shown in the Figures, but will be collectively referenced as “236” for the sake of this description.) Each swage ring 236 includes a tapered distal ring edge 238 which is laterally interposed between the proximal body extension 216 and the tube 102 as the fitting 100 is assembled. Each swage ring 236 includes a proximal ring edge 240 configured for selective engagement and driving contact—indirectly or directly, as mentioned below—with the ring driving lip 230.

When the fitting 100 is assembled and/or installed, the body 204, driver 222, at least one swage ring 236, and tube 102 may be arranged concentrically around a common longitudinal axis A. As shown in the Figures, it is contemplated that none of the body 204, driver 222, and at least one swage ring 236 may include screw threads (to assist with makeup of the fitting 100) for many use environments of the fitting 100. Instead, the body 204, driver 222, and/or swage ring(s) 236 slide axially relative to one another to achieve the elastic strain preload condition shown and described herein. As a result, the assembly of the fitting 100 may be done in a purely sliding, such as substantially axially sliding, manner, as described herein, rather than via a threaded or rotational connection. This lack of screw threads may assist with reducing manufacturing time and costs, and may also be helpful in forming desired swaging relationships using the fitting 100 (including components thereof) and the tube 102. A lubricant (e.g., an oxygen-compatible lubricant in medgas use environments) could be provided at any point during manufacture, assembly, and/or use of the fitting 100 to aid with achieving the described sliding relationships.

A tool flange 242 and/or tool groove 244 could be provided on the annular body 204 to provide a “gripping point” for engagement of a makeup and/or installation tool such as a manually or automatically powered press (not shown) with the fitting 100. The tool flange 242 could also or instead be used as a “stop” feature to facilitate a limit on desired travel of the driver 222 distally along the body 204. Since the axial forces needed to “snap” the driver detent feature 228 into the depicted engagement with the detent step 214 are very large, one of ordinary skill in the art can provide some powered and/or mechanically advantaged tool to assist with manufacturing and/or end user installation of the fitting 100 on the tube 102 as desired. From a detail perspective, the tool flange 242 and tool groove 244 assists the installation tool (not shown) to hold the body 204 relatively stationary as the tool pushes the driver 222 (specifically, the inner driver surface 224) “up” and distally along and past the proximal body extension 216.

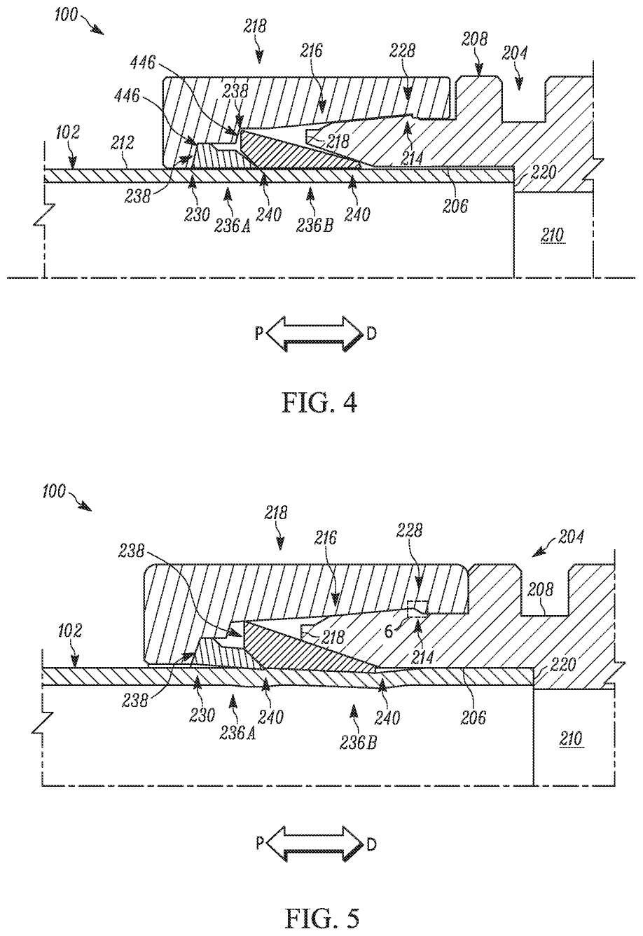

Each swage ring 236 may be skived into the tube 102 under the predetermined compression force F. The term “skive” is used herein as a term of art indicating that the distal ring edge 238 bites or shaves into the outer tube surface 212. Skiving of the swage ring(s) 236 into the outer tube surface 212 can deform the tube 102, as shown in the sequence of FIGS. 4-5. This biting interaction of the swage ring(s) 236 into the tube 102 also provides a substantially fluidtight seal by bringing the swage ring(s) 236 into such tight contact with the outer tube surface 212 that fluid (e.g., liquid[s] and/or gas[es]) cannot pass therebetween. Therefore, the skived relationship shown in FIG. 5 is considered a substantially fluidtight “sealing contact”. The term “substantially fluidtight” is used herein to indicate a sealing relationship that may be absolutely fluidtight, but also may admit of a de minimis amount of incidental fluid passage therethrough that is acceptable within the installation parameters for the tube 102. This skiving relationship can be enhanced when the at least one swage ring 236 is made of a first material (e.g., 440C hardened stainless steel), the tube 102 is made of a second material (e.g., C27450 brass), and the first material is harder than the second material. It should be noted, especially with respect to the exploded views of FIGS. 2-3, that the outer tube surface 212 is shown as including grooves formed under influence of the skiving action. Before the installation procedure is performed, it is contemplated that the outer tube surface 212 will be substantially even and cylindrical, for most use environments.

The driver 222, being slid distally forward over the body 204, selectively exerts a predetermined compression force F laterally inward toward the tube 102 to urge the at least one swage ring 236 into a sealing contact with the tube 102 and responsively place the tube 102 into the elastic strain preload condition. As mentioned above, the driver detent feature 228 concurrently engages at least a portion of the detent step 214 to resist proximal motion of the driver 222 with respect to the body 204.

It is contemplated that the driver 222 can exert both compressive hoop stress and longitudinal force upon the at least one swage ring 236 when the driver detent feature 228 is engaged with the detent step 214. This concept will now be explored in further detail with respect to FIGS. 4-6.

The fitting 100 includes an annular body 204, and annular driver 222, and at least one swage ring 236. The body 204 includes assembly and installation detent features (shown in FIG. 6 as “steps” numbered 632 and 634) comprising a detent step 214. The assembly detent feature 632 is used in helping the fitting 100 achieve the factory-assembled condition and holds the driver 222 and swage ring(s) 236 onto the body 204 by axially loading the driver detent feature 228 into the assembly detent feature 632. The second phase of relative axial movement of the body 204 and driver 222 brings the driver detent feature 228 into engagement with the installation detent feature 634 and thus moves the fitting 100 into the installation condition, permanently holding the fitting 100 together.

The driver 222 and swage ring(s) 236 are pressed onto the annular body 204 during manufacture, such as at a factory. As the driver 222 moves “up” the proximal body extension 216, at the tapered angle between the proximal body rim 218 and the detent step 214, the driver 222 expands diametrically, creating a pressed-on, axially loaded assembled condition in the fitting 100. This assembled condition means that the swage ring(s) 236 are held in place and a one-piece fitting 100 is created for use by the end user installer. This factory assembly step will help prevent any ring mixing, inverting, turning or other assembly problems normally seen with threaded compression fittings assembled in the field or otherwise by an end user. The fitting 100, as shown in FIG. 4, is now in a condition to be installed by an end user.

The various aspects of the detent step 214 and driver detent feature 228, as well as the arrangements angles of the interfacing portions of the body 204 and driver 222 are designed to assist the driver 222 to elastically “snap” into engagement with the assembly and installation detent features 632 and 634 during assembly and installation, respectively. When the driver 222 is moved over detent step 214, the compressive hoop stress in the driver 222 will urge the driver 222 into compressive contact with the angles of the detent step 214, creating a forward force/action represented by resolved arrow “FF” in FIG. 6. This forward force/action will cause the swage ring(s) 236 to be constantly pulled distally, as well, creating an additional “live loading” on the fitting 100 connection to the tube 102, as desired.

As alluded to previously, the at least one swage ring 236 may be a primary swage ring 236B, and the axial swaged fitting 100 may include, for many use environments, a secondary swage ring 236A laterally interposed between the tube 102 and the driver 222, as desired. The primary and secondary swage rings 236B and 236A may be of any similar or different designs as appropriate to develop the desired skiving and/or force relationships within the fitting. The secondary swage ring 236A, when present, may include a tapered distal secondary ring edge 238 laterally interposed between the proximal ring edge 240 of the primary swage ring 236B and the tube 102. This arrangement is shown in at least FIGS. 4-5. The secondary swage ring 236A, when present, includes a proximal secondary ring edge 238 configured for selective engagement with the ring driving lip 230 of the driver 222, with that engagement being direct (through direct contact therebetween) and/or indirect (with at least a portion of the force from the ring driving lip 230 being transmitted to the secondary swage ring 236A through another structure, such as the primary swage ring 236B). Similarly, the presence of the secondary swage ring 236A could result in force from the ring driving lip 230 being transmitted to the primary swage ring 236B in an indirect manner. While two swage rings 236 are described and shown herein, it is contemplated that the fitting 100 could include any desired number and/or configuration(s) of swage rings 236, including a potential single-ring arrangement having multiple edges to skive into the outer tube surface 212. When more than one swage ring 236 is provided, a “backup” or redundant sealing function is provided to the fitting 100, which may be desirable in some use environments.

When a secondary swage ring 236A is provided, the driver 222 selectively exerts a predetermined compression force laterally inward toward the tube 102 to urge the secondary swage ring 236A into a sealing contact with the tube 102 and responsively place the tube 102 into the elastic strain preload condition. The driver detent feature 228, again, will concurrently engage the detent step 214 to resist proximal motion of the driver 222 with respect to the body 204.

As shown in the Figures, the ring driving lip 230 may be a stepped ring driving lip. At least one step 446 of the stepped ring driving lip 230 may be configured to exert a longitudinally oriented force on one or more of the swage ring(s) 236. That is, each step 446 may come into force-transmitting contact with at least one swage ring 236. The step(s) 446 may also or instead be provided to allow some “relief space” for relative movement and/or deformation of the swage ring(s) 236 relative to one another and/or to other features of the fitting 100. Additionally, the step(s) 446 could help direct and/or control the amount of swaging and skiving of the swage ring(s) 236 into the tube 102.

It is contemplated that the fitting 100 could be employed, in some use environments, for interconnecting the tube 102 to at least one other tube (shown schematically via dashed line 102′ in FIG. 1). In this manner, the fitting 100 could be used to permanently swage two or more tubes into a straight connection, a tee connection, a “plus”-shaped cruciform connection, or in any other desired manner. For two-tube straight connection use environments, for example, the body 204 could be substantially mirrored about the lateral line M shown in FIG. 1, and additional copies of the other components could be provided. Accordingly, for multi-tube connection use environments, the body 204 will laterally surround at least a portion of the other tube 102′. The body 204 will then include a second detent step 214′ laterally aligned with at least a portion of the tube bore 210′ and longitudinally spaced distally from the first detent step 214. The annular body 204 includes a tapered distal second body extension 216′, the driver 222 is a first driver 222, the at least one swage ring 236 is at least one first swage ring 236. The fitting 100 will be configured as shown in FIGS. 1 and 3, with installation of the second side being similar to that described above and shown in the Figures, but for mirrored nomenclature and actions. The fitting 100 in this “doubled sided” configuration includes an annular second driver 222′ including a second driver detent feature 228′ longitudinally and distally spaced from a second ring driving lip 230′. The second driver detent feature 228′ directly laterally surrounds the distal second body extension 216′ and the second ring driving lip 230′ directly laterally surrounds a portion of the other tube 102′. The second driver 222′ is configured for selective proximal sliding motion with respect to the other tube 102′ and body 204 to bring the second driver detent feature 228′ into selective engagement with the second detent step 214′ at least partially via elastic deformation of the second driver detent feature 228′ under influence of the tapered distal second body extension 216′.

In this double-sided configuration, at least one second swage ring 236′ may be laterally interposed between the other tube 102′ and the second driver 222′. The second swage ring 236′ including a tapered second proximal ring edge 238′ laterally interposed between the distal second body extension 216′ and the other tube 102′. The second swage ring 236′ includes a distal ring edge 240′ configured for selective engagement with the second ring driving lip 230′. The second driver 222′ selectively exerts a predetermined compression force laterally inward toward the other tube 102′ to urge the at least one second swage ring 236′ into a sealing contact with the other tube 102′ and responsively place the other tube 102′ into the elastic strain preload condition. The second driver detent feature 228′ concurrently engages the second detent step 214′ to resist distal motion of the second driver 222′ with respect to the body 204. It should be noted that, in FIG. 1, the right side (“second”), mirrored arrangement of structures is shown in an assembly condition, and the left side (“first”) arrangement of structures (initially described at length above) is shown in an installed condition.

A desired configuration of deformations and relative contacting forces between/among the structures of the fitting 100 could be provided by one of ordinary skill in the art for a particular use environment, such as by choosing materials for the fitting 100 structures having particular hardnesses or other physical properties.

A method of permanently joining an axial swaged fitting 100 to a tube 102 to achieve an elastic strain preload condition will be described. While certain structures of the fitting 100 are described as being associated with each other in various preassembly and assembly stages, it is contemplated that the various parts of the fitting 100 could be conglomerated in any desired combinations and sequences. For example, certain combinations of components could be preassembled together by a manufacturer, with the final assembly of the fitting 100 onto a tube 102 occurring in the field by a user. The below description presumes the use of a fitting 100 as described above and shown in the Figures.

At least a portion of the body 204 is laterally surrounded with an annular driver 222 including a driver detent feature 228 longitudinally spaced from a ring driving lip 230. At least one swage ring 236 is placed laterally inside the driver 222. (When a tube 102 is introduced into a tube bore 210 of the fitting 100, the at least one swage ring 236 will be laterally imposed between the tube 102 and the driver 222.) The body 204 and the driver 222 are brought into at least partial lateral contact. The driver 222 is brought into at least partial lateral contact with the at least one swage ring 236. In many use environments, the assembly process described in this paragraph could be accomplished manually, optionally with the use of simple, non-powered hand tools.

Once the fitting 100 components have been initially placed as just described in the previous paragraph, the driver 222 can be slid longitudinally distally along the body 204 and into the “assembled” condition, as depicted on the rightmost side of FIG. 1. This could be done manually, optionally with the assistance of simple, non-powered hand tools.

Alternatively, an assembler (e.g., a factory worker) may need to use powered tools (e.g., electrically and/or fluid-powered tools) to slide the driver 222 into the position shown on the right side of FIG. 1, particularly for larger-bore fittings 100.

In this portion of the assembly process, the driver 222 could be slid substantially axially along the body 204 with no significant lateral motion of the driver 222 with respect to the body 204. The driver 222, body 204, or any other portion of the fitting 100 could include a user-perceptible marking to help with alignment and/or achieving a desired degree of engagement between the driver 222 and body 204 in a repeatable manner. Sliding the driver 222 longitudinally distally along the body 204 may exclude bringing the driver into threaded engagement with any of the body 204, the tube 102, and the at least one swage ring 236, during all phases of assembly, installation, and use of the fitting 100.

To achieve the “assembled” condition shown on the rightmost side of FIG. 2, the driver 222 is used to exerting a predetermined compression force F at least one of laterally inward (i.e., toward the tube bore 210 and toward any tube 102 present in the tube bore 210) and longitudinally distally. Movement of the driver 222 imposes predetermined longitudinal and lateral forces on the at least one swage ring 236 during engagement of the detent step 214 and driver detent feature 228. For example, a longitudinally distal force may be exerted (indirectly and/or directly) upon the at least one swage ring 236 with the ring driving lip 230.

As described above with reference to the engagement of the assembly detent feature 632 and the driver detent feature 228, predetermined longitudinal and lateral forces may be maintained on the at least one swage ring 236 over a period of time after engagement of the detent step 214 and driver detent feature 228. Stated differently, there may be some degree of force exerted and maintained upon the at least one swage ring 236 through action of the driver 222 even when the fitting 100 is assembled with no tube 102 in the tube bore 210. That period of time could be one or more days, and—when present—is related to the amount of time between assembly of the fitting 100 at a manufacturing facility and installation of the fitting 100 by an end user in the field or by a middleman creating tubes 102 with installed fittings 100 for later use. Alternatively, the entire assembly of the fitting 100 into a fully installed “use” condition could be done wholly in the field or in a manufacturing facility, depending upon the use environment.

Once the fitting 100 has achieved the assembled configuration shown on the rightmost side of FIG. 1 (note the gap between the front of the driver 222′ and the tool flange 242′), the tube 102 may be introduced into the tube bore 210 of the body 204 at any desired installation time (which, as above, may be a significant amount of time after the fitting 100 was assembled). At least a portion of the tube 102 would then be laterally surrounded with the body 204. The driver 222 can then be once again slid axially along the body 204 and into further engagement of the detent step 214 with the driver detent feature 228 to provide at least a predetermined compression force F. The compression force F may be a laterally inward compressive force exerted upon the at least one swage ring 236 with cooperative action of the body 204 and driver. A longitudinally oriented force could also or instead be exerted upon the at least one swage ring 236 to urge the swage ring 236 forward into the aforementioned swaging relationship.

In more specific detail, and as described above with reference to at least FIG. 6, the detent step 214 and driver detent feature 228 can be engaged via elastic deformation of the driver 222. With the body 204, a distal portion of the driver 222 is wedged or urged laterally away from the tube 102 to elastically deform the driver 222 as the driver 222 slides longitudinally distally along the body 204. Still under influence of that wedging action, the driver detent feature 228 is slide longitudinally distally and over the detent step 214, until the driver detent feature 228 snaps laterally inward distal to the detent step 214 to place at least a portion of the driver 222 laterally inwardly from the furthest outward extent (from the central axis A) of the detent step 214, both proximal and distal to the detent step 214.

With at least the predetermined compression force F, the at least one swage ring 236 is urged laterally inward to deform the tube 102 to achieve the elastic strain preload condition, into the “installed” condition shown on the leftmost side of FIG. 1. The tube 102 can then be considered “sealed” into the fitting 100, and will remain in the installed condition for an extended, even long enough to be considered permanent, period of time during use of the piping system of which the tube 102 forms a part. That is, the fitting 100 and tube 102 can be maintained in the elastic strain preload condition through cooperative engagement of the detent step 214 and the driver detent feature 228.

One of ordinary skill in the art can readily understand that the fitting 100 could be configured in any desired manner, for engaging the tube 102 with at least one other tube or any other structure at any intersection angle and using any desired fastening scheme, including, but not limited to, similar elastic strain preloading as with the tube 102, threading, brazing, welding, frictional or interference fit, and/or any other desired direct or indirect attachment schemes. For example, and as shown in FIG. 7, the annular body 204 includes a threaded end T facilitating thread-based tie-in of the tube 102 to another structure (e.g., a medical gas source). Though not shown, it is also contemplated that the fitting 100 could have a “blind end” of the tube bore 210, to cap off the tube 102 without connecting it to any other structure.

It is also contemplated that a fitting 100 could be configured to provide at least one metal-to-metal seal with a tube 102, the seal being configured for use under pressure/temperature conditions up to the rating of the tubing. For example, in some medgas use environments, the fitting 100 could have a temperature rating of not less than 538° C. (1000° F.) and a pressure rating of not less than 2070 kPa (300 psi). The fitting 100 could provide a permanent (i.e., not capable of being reversed or returned to the original condition) and nonseparable seal that can be used to join any type(s) of tubing or piping, including copper and stainless steel. The fitting 100 could have any suitable dimensions, as desired for a particular use environment. For example, for use with a tube 102 having an OD (taken laterally) of about 0.375″, the fitting could have an OD (taken laterally) in the range of about 3″-4″ and a total longitudinal length in the range of about 5″-6″.

It is also contemplated that the tube 102 and fitting 100 could be engaged into the installed condition and maintained there for a predetermined but limited period of time, and then the driver 222 slid proximally to reverse the above-described procedure and release the tube 102. In the configuration shown as an example herein, such disassembly might cause damage to one or more components of the fitting 100, but one of ordinary skill in the art could provide a “reversible” fitting (not shown) that includes sacrificial/replaceable components and/or is designed to allow for disassembly without such damage.

While aspects of this disclosure have been particularly shown and described with reference to the example aspects above, it will be understood by those of ordinary skill in the art that various additional aspects may be contemplated. For example, the specific methods described above for using the apparatus are merely illustrative; one of ordinary skill in the art could readily determine any number of tools, sequences of steps, or other means/options for placing the above-described apparatus, or components thereof, into positions substantively similar to those shown and described herein. In an effort to maintain clarity in the Figures, certain ones of duplicative components shown have not been specifically numbered, but one of ordinary skill in the art will realize, based upon the components that were numbered, the element numbers which should be associated with the unnumbered components; no differentiation between similar components is intended or implied solely by the presence or absence of an element number in the Figures. Any of the described structures and components could be integrally formed as a single unitary or monolithic piece or made up of separate sub-components, with either of these formations involving any suitable stock or bespoke components and/or any suitable material or combinations of materials. Any of the described structures and components could be disposable or reusable as desired for a particular use environment. Any component could be provided with a user-perceptible marking to indicate a material, configuration, at least one dimension, or the like pertaining to that component, the user-perceptible marking potentially aiding a user in selecting one component from an array of similar components for a particular use environment. A “predetermined” status may be determined at any time before the structures being manipulated actually reach that status, the “predetermination” being made as late as immediately before the structure achieves the predetermined status. The term “substantially” is used herein to indicate a quality that is largely, but not necessarily wholly, that which is specified—a “substantial” quality admits of the potential for some relatively minor inclusion of a non-quality item. Though certain components described herein are shown as having specific geometric shapes, all structures of this disclosure may have any suitable shapes, sizes, configurations, relative relationships, cross-sectional areas, or any other physical characteristics as desirable for a particular application. Any structures or features described with reference to one aspect or configuration could be provided, singly or in combination with other structures or features, to any other aspect or configuration, as it would be impractical to describe each of the aspects and configurations discussed herein as having all of the options discussed with respect to all of the other aspects and configurations. A device or method incorporating any of these features should be understood to fall under the scope of this disclosure as determined based upon the claims below and any equivalents thereof.

Other aspects, objects, and advantages can be obtained from a study of the drawings, the disclosure, and the appended claims.

We claim:

1. An axial swaged fitting for permanently joining to a tube to achieve an elastic strain preload condition, the fitting comprising:
an annular body including a tube bore laterally surrounding at least a portion of the tube, the annular body including a detent step laterally aligned with at least a portion of the tube bore, and the annular body including a tapered proximal body extension;
an annular driver including a driver detent feature longitudinally spaced from a ring driving lip, the driver detent feature directly laterally surrounding the proximal body extension and the ring driving lip directly laterally surrounding a portion of the tube, the driver being configured for selective distal sliding motion with respect to the tube and body to bring the driver detent feature into selective engagement with the detent step at least partially via elastic deformation of the driver detent feature under influence of the tapered proximal body extension; and
at least one swage ring laterally interposed between the tube and the driver, the swage ring including a tapered distal ring edge laterally interposed between the proximal body extension and the tube, and the swage ring including a proximal ring edge configured for selective engagement with the ring driving lip; and
wherein the driver selectively exerts a predetermined compression force laterally inward toward the tube to urge the at least one swage ring into a sealing contact with the tube and responsively place the tube into the elastic strain preload condition, and the driver detent feature concurrently engages the detent step to resist proximal motion of the driver with respect to the body.

2. The axial swaged fitting of claim 1, wherein the body, driver, at least one swage ring, and tube are arranged concentrically around a common longitudinal axis.

3. The axial swaged fitting of claim 1, wherein the at least one swage ring is a primary swage ring, and the axial swaged fitting includes a secondary swage ring laterally interposed between the tube and the driver, the secondary swage ring including a tapered distal secondary ring edge laterally interposed between the proximal ring edge of the primary swage ring and the tube, and the secondary swage ring including a proximal secondary ring edge configured for selective engagement with the ring driving lip; and
wherein the driver selectively exerts a predetermined compression force laterally inward toward the tube to urge the secondary swage ring into a sealing contact with the tube and responsively place the tube into the elastic strain preload condition, and the driver detent feature concurrently engages the detent step to resist proximal motion of the driver with respect to the body.

4. The axial swaged fitting of claim 1, wherein the at least one swage ring is made of a first material, the tube is made of a second material, and the first material is harder than the second material.

5. The axial swaged fitting of claim 4, wherein the distal ring edge skives into an outer surface of the tube to provide a fluidtight seal therebetween.

6. The axial swaged fitting of claim 1, for interconnecting the tube to an other tube in a fluidtight manner, wherein the tube bore laterally surrounds at least a portion of the other tube concurrently with surrounding at least a portion of the tube, the body includes a second detent step laterally aligned with at least a portion of the tube bore and longitudinally spaced distally from the first detent step, the annular body including a tapered distal second body edge, the driver is a first driver, the at least one swage ring is at least one first swage ring, and the fitting includes:
an annular second driver including a second driver detent feature longitudinally and distally spaced from a second ring driving lip, the second driver detent feature directly laterally surrounding the distal second body edge and the second ring driving lip directly laterally surrounding a portion of the other tube, the second driver being configured for selective proximal sliding motion with respect to the other tube and body to bring the second driver detent feature into selective engagement with the second detent step at least partially via elastic deformation of the second driver detent feature under influence of the tapered distal second body edge; and
at least one second swage ring laterally interposed between the other tube and the second driver, the second swage ring including a tapered second proximal ring edge laterally interposed between the distal second body edge and the other tube, and the second swage ring including a distal ring edge configured for selective engagement with the second ring driving lip; and
wherein the second driver selectively exerts a predetermined compression force laterally inward toward the other tube to urge the at least one second swage ring into a sealing contact with the other tube and responsively place the other tube into the elastic strain preload condition, and the second driver detent feature concurrently engages the second detent step to resist distal motion of the second driver with respect to the body.

7. The axial swaged fitting of claim 1, wherein the ring driving lip is a stepped ring driving lip, and at least one step of the stepped ring driving lip is configured to exert a longitudinally oriented force on one or more of the at least one swage ring.

8. The axial swaged fitting of claim 1, wherein the detent step includes an assembly detent feature and an installation detent feature, the assembly detent feature being laterally further from the tube bore than the installation detent feature, and both the assembly and installation detent features extending laterally further from the tube bore than the driver detent feature when not engaged with the detent step.

9. The axial swaged fitting of claim 1, wherein none of the body, driver, and at least one swage ring include screw threads.

10. An axial swaged fitting for permanently joining to a tube, the fitting comprising:
an annular body including laterally spaced, concentrically extending, and oppositely facing inner body and outer body surfaces, the inner body surface including a tube bore directly adjacent to an outer tube surface of the tube, the outer body surface including at least one detent step laterally aligned with at least a portion of the tube bore, the annular body including a tapered proximal body extension having a proximal body rim interposed laterally between the inner body and outer body surfaces, the outer and inner body surfaces tapering toward each other in a proximal direction;
an annular driver including laterally spaced, concentrically extending, and oppositely facing inner driver and outer driver surfaces, the outer driver surface including a driver detent feature longitudinally spaced from a ring driving lip of the inner driver surface, the inner driver surface tapering laterally outward in a distal direction, the driver detent feature directly laterally surrounding the proximal body extension and the ring driving lip directly laterally surrounding a portion of the tube, the driver being configured for selective distal sliding motion with respect to the tube and body to bring the driver detent feature into selective engagement with the detent step at least partially via elastic deformation of the driver detent feature under influence of wedging interaction between the inner driver surface and the tapered proximal body extension; and
at least one swage ring laterally interposed between the tube and the driver, the swage ring including a tapered distal ring edge laterally interposed between the proximal body extension and the tube, and the swage ring including a proximal ring edge configured for selective engagement with the ring driving lip; and
wherein the driver selectively exerts a predetermined compression force laterally inward toward the tube to urge the at least one swage ring into a sealing contact with the tube and responsively place the tube into the elastic strain preload condition, and the driver detent feature concurrently engages the detent step to resist proximal motion of the driver with respect to the body.

11. The axial swaged fitting of claim 10, wherein the detent step includes an assembly detent feature and an installation detent feature, the assembly detent feature being laterally further from the tube bore than the installation detent feature, and both the assembly and installation detent features extending laterally further from the tube bore than the driver detent feature when not engaged with the detent step.

12. The axial swaged fitting of claim 11, wherein the detent step is engaged, and maintained in engagement, with the assembly detent feature during a manufacturing operation a significant amount of time before the detent step is engaged, and maintained in engagement, with the installation detent feature during an installation operation.

13. The axial swaged fitting of claim 10, for interconnecting the tube to an other tube in a fluidtight manner, wherein the tube bore laterally surrounds at least a portion of the other tube concurrently with surrounding at least a portion of the tube, the body includes a second detent step laterally aligned with at least a portion of the tube bore and longitudinally spaced distally from the first detent step, the annular body including a tapered distal second body edge, the driver is a first driver, the at least one swage ring is at least one first swage ring, and the fitting includes:
an annular second driver including a second driver detent feature longitudinally and distally spaced from a second ring driving lip, the second driver detent feature directly laterally surrounding the distal second body edge and the second ring driving lip directly laterally surrounding a portion of the other tube, the second driver being configured for selective proximal sliding motion with respect to the other tube and body to bring the second driver detent feature into selective engagement with the second detent step at least partially via elastic deformation of the second driver detent feature under influence of the tapered distal second body edge; and
at least one second swage ring laterally interposed between the other tube and the second driver, the second swage ring including a tapered second proximal ring edge laterally interposed between the distal second body edge and the other tube, and the second swage ring including a distal ring edge configured for selective engagement with the second ring driving lip; and
wherein the second driver selectively exerts a predetermined compression force laterally inward toward the other tube to urge the at least one second swage ring into a sealing contact with the other tube and responsively place the other tube into the elastic strain preload condition, and the second driver detent feature concurrently engages the second detent step to resist distal motion of the second driver with respect to the body.

14. The axial swaged fitting of claim 10, wherein the driver exerts both compressive hoop stress and longitudinal force upon the at least one swage ring when the driver detent feature is engaged with the detent step.

15. A method of permanently joining an axial swaged fitting to a tube to achieve an elastic strain preload condition, the method comprising:
laterally surrounding a portion of the tube with an annular body including a detent step;
laterally surrounding at least a portion of the body with an annular driver including a driver detent feature longitudinally spaced from a ring driving lip;
laterally imposing at least one swage ring between the tube and the driver;
bringing the body and driver into at least partial lateral contact;
bringing the driver into at least partial lateral contact with the at least one swage ring;
sliding the driver longitudinally distally along the body;
with the driver, exerting a predetermined force at least one of laterally inward toward the tube and longitudinally distally; and
with the predetermined compression force, urging the at least one swage ring laterally inward to deform the tube to achieve the elastic strain preload condition;
engaging the detent step and driver detent feature via elastic deformation of the driver; and
maintaining the elastic strain preload condition through cooperative engagement of the detent step and the driver detent feature.

16. The method of claim 15, wherein engaging the detent step and driver detent feature via elastic deformation of the driver includes:
with the body, wedging a distal portion of the driver laterally away from the tube to elastically deform the driver as the driver slides longitudinally distally along the body;
sliding the driver detent feature longitudinally distally and over the detent step; and
snapping the driver detent feature laterally inward distal to the detent step to place at least a portion of the driver laterally inwardly from the detent step both proximal and distal to the detent step.

17. The method of claim 15, including
imposing predetermined longitudinal and lateral forces on the at least one swage ring during engagement of the detent step and driver detent feature; and
maintaining predetermined longitudinal and lateral forces on the at least one swage ring over a period of time after engagement of the detent step and driver detent feature.

18. The method of claim 15, wherein sliding the driver longitudinally distally along the body includes sliding the driver substantially axially along the body with no significant lateral motion of the driver with respect to the body.

19. The method of claim 15, wherein urging the at least one swage ring laterally inward to deform the tube to achieve the elastic strain preload condition includes:
exerting longitudinally distal force upon the at least swage ring with the ring driving lip; and
exerting laterally inward compressive force upon the at least one swage ring with cooperative action of the body and the driver.

20. The method of claim 15, wherein sliding the driver longitudinally distally along the body excludes bringing the driver into threaded engagement with any of the body, the tube, and the at least one swage ring.
